(19) United States
(12) Patent Application Publication
(10) Pub. No.: US 2013/0298446 A1
(43) Pub. Date: Nov. 14, 2013

(54) ATMOSPHERIC DIFFUSER APPARATUS

(71) Applicant: PIC Corporation, Linden, NJ (US)

(72) Inventor: Phyllis Rubel, Westfield, NJ (US)

(21) Appl. No.: 13/942,372

(22) Filed: Jul. 15, 2013

Related U.S. Application Data
(63) Continuation of application No. 12/790,446, filed on May 28, 2010.

(51) Int. Cl. A01M 1/20

(52) U.S. Cl. CPC A01M 1/2055
USPC 43/132.1

(57) ABSTRACT

An insect repellent scent diffusing apparatus including a container having a bottom wall and a continuous side wall surface extending from the bottom wall. A plurality of apertures are formed in the continuous side wall surface. An element containing insect repellent scent is disposed in the container and configured to diffuse insect repellent scent through the plurality of apertures and into the surrounding atmosphere.

### CROSS REFERENCE TO RELATED APPLICATIONS

The present application is a continuation of U.S. patent application Ser. No. 12/790,446, filed May 28, 2010, the contents of which are incorporated herein by reference in its entirety.

### FIELD OF THE INVENTION

The invention relates to dispensing apparatus, and more particularly to apparatus for dispensing insecticide into the atmosphere.

### BACKGROUND OF THE INVENTION

An insect repellent is a substance which may come in many forms and applications, including being applied to skin, clothing, or other surfaces which discourages insects (and arthropods in general) from landing or climbing on that surface. Insect repellents help prevent and control the outbreak of insect-borne diseases such as malaria, Lyme disease, Dengue fever, bubonic plague, and West Nile fever. Pest animals commonly serving as vectors for disease include the insects flea, fly, and mosquito; and the arachnid tick. Usually insect repellents work by masking human scent, or by using a scent which insects naturally avoid. Common insect repellents include: DEET; Essential oil of the lemon eucalyptus and its active compound p-menthane-3,8-diol (PMD); Icaridin, also known as picaridin, Bayrepel, and KBR 3023; Nepetalactone, also known as “catnip oil”; Citronella oil; Permethrin; Neem oil; and Bog Myrtle

A know prior art method of diffusing insect repellents into the atmosphere was through allowing diffusion of vapor or smoke into the surroundings of the device, and particularly, but not exclusively, to devices allowing diffusion of dry smoke produced from a combustible solid.

It is known to use a diffusion to burn incense in order to introduce fragrance into a room. The introduction of fragrance into a room can be a mood enhancer and can also mask unwanted household odors such as those caused by cooking, tobacco, pets, etc.

It is also known to use a diffusion to burn solid blocks of combustible material, incorporating either fragrance or other additives such as insecticides etc. However, known diffusion methods suffer from problems relating to heat transfer from the diffusion to the surface on which the diffuser is positioned, and inefficient burning of the solid block resulting in sub-optimal burning of the solid block. Further, with known diffusion it is common for the ash from the burnt solid block to spill over from the diffusion onto a surface on which the diffuser is positioned.

Other known methods for diffusing or dispersing insect repellents into the atmosphere include: aerosol vapor delivery systems (e.g., OFF™ spray); smoke barriers in which flames originating from a material are extinguished wherefter the material continues to generate smoke which acts as an insect deterrent (e.g., burning mosquito coils); using open flames (e.g., burning citronella candles); battery and/or electric operated devices configured and operable to attract or repel insects; and skin lotions having insect repellent qualities.

### SUMMARY OF THE INVENTION

In one aspect, an apparatus for diffusing insect repellent scents into the atmosphere in accordance with certain illustrated embodiments is disclosed. It is noted, some of the advantages provided by the present invention in accordance with the illustrated embodiments include; no open flame is used (which obviates the accompanying fire hazard and/or potential for skin burn); no aerosols are used (which obviates the use of accompanying air pollutants); no lotions need to be applied to skin; and there are no associated operational costs.

The apparatus includes a container having a bottom container member defining a bottom wall and a continuous side wall surface extending from the bottom wall. The bottom container member has a first outer surface and a second outer surface extending from the first outer surface. The second outer surface forms a top portion of the bottom container member. A plurality of apertures are defined in the top portion of the second outer surface for diffusing insect repellent scents.

The container further includes a top lid member configured to detachably attach to the top portion of the bottom container wherein the first outer surface of the bottom container member has a circumference substantially identical to that of the outer surface of the top lid member and the second outer surface of the bottom container member has a circumference which is less than that of the outer surface of the top lid member such that the top lid member slideably receives on the second outer surface of the bottom container member. The top lid member is movable from a first position wherein all of the apertures of the bottom container member are concealed to a second position in which at least some of the apertures of the bottom container member are exposed when abutting portions of respective patterns provided on the top lid member and the bottom container member are caused to abut one another.

The container further includes an element disposed in the container and configured to diffuse insect repellent scent through the exposed apertures and into the surrounding atmosphere when the top lid member is in the second position.

### BRIEF DESCRIPTION OF THE DRAWINGS

The objects and features of the invention can be understood with reference to the following detailed description of an illustrative embodiment of the present invention taken together in conjunction with the accompanying drawings in which:

FIG. 1 is an exploded view of the present invention in accordance with an illustrated embodiment;

FIG. 2 depicts the present invention of FIG. 1 in a closed position; and

FIG. 3 depicts the present invention of FIG. 3 in an open position.

### WRITTEN DESCRIPTION OF CERTAIN EMBODIMENTS OF THE INVENTION

The present invention is now described more fully with reference to the accompanying drawings, in which illustrated embodiments of the present invention are shown. The present invention is not limited in any way to the illustrated embodiments as the illustrated embodiments described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

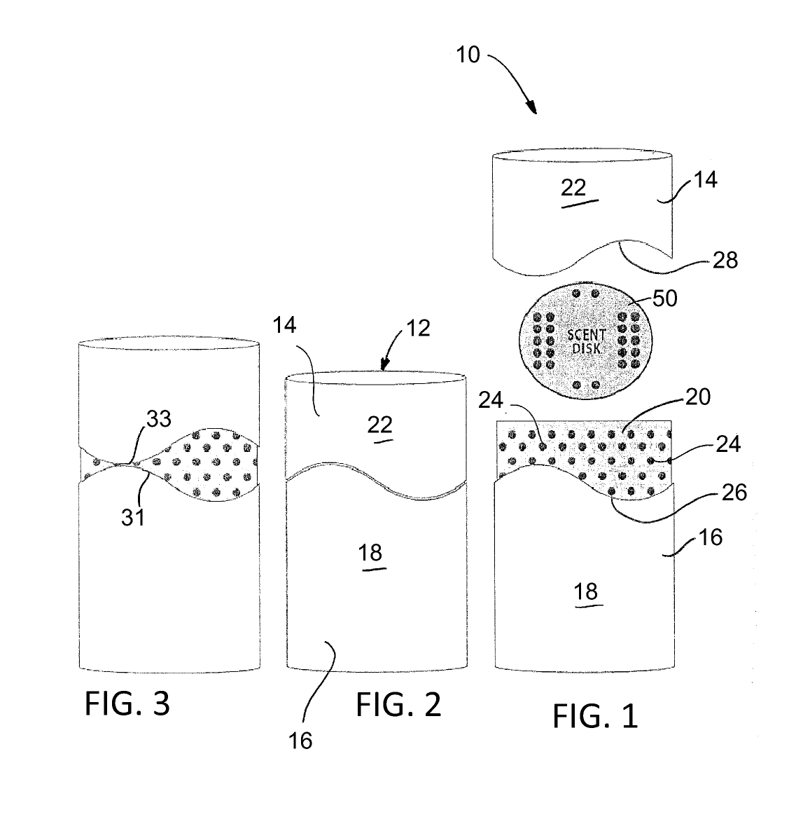

Turning now descriptively to the drawings, in which similar reference characters denote similar elements throughout the several views, FIG. 1 depicts an insect repellent diffusion delivery system, designated generally by reference numeral 10, in accordance with the certain illustrated embodiments of the invention. Delivery system 10 includes a container 12 having a top lid member 14 and a bottom container member 16 each configured to detachably fit with one another to form the container 12 depicted in FIG. 2. The top lid member 14 and bottom container member 16 are preferably cylindrically shaped and each has a closed bottom wall surface and an opposing open top surface, as illustrated. However, container 10 is not to be understood to be limited to having a cylindrical shape as it may be configured to have numerous other shapes.

Preferably, an element 50 configured to emit (or diffuse) an insect repellent scent, is removably disposed in the bottom container member 16. The element 50 depicted in FIG. 1 is shown in the shape of a disc. However, it is no to be understood to be limited thereto as it may encompass any form or shape capable of emitting (or diffusing) an insect repellent scent that may be disposed within the container 12. For instance, the element can be in the form of a liquid or the interior surface portion of one of, or both, the top lid member 14 and bottom container member 16 is infused, impregnated, saturated or coated with an insect repellent scent.

As depicted in FIG. 1, the bottom container member 16 is configured to have a first outer surface 18 and a second outer surface 20 extending from the first outer surface 18. The second outer surface 20 forms the top portion of the bottom container member 16. It is to be appreciated that the first outer surface 18 preferably has a circumference which is substantially identical to that of the outer surface 22 of the top lid member 14, and the second outer surface 20 of the bottom container member 16 has a circumference which is less than that of the outer surface 22 of the top lid member 14.

A top portion of the second outer surface 20 of the bottom container member 16 is provided with a plurality of apertures 24. Additionally, the first outer surface 18 of the bottom container member 16 defines a serpentine or wavelike like pattern 26 along its upper surface. Likewise, the bottom surface 28 of the top lid member 14 is also preferably formed with a serpentine or wave like pattern 28 similar to that of the serpentine or wave pattern 26 of the first outer surface 18 of the bottom container member 16.

As shown in FIG. 2, when the top lid member 14 is fitted to the bottom container member 16, and their respective aforesaid serpentine or wave like patterns 26, 28 are caused to align with one another, each of the plurality of apertures 24 of the bottom container member 16 are concealed by the top lid member 14. Thus, the container 10 is to be understood to be in a closed position preventing vapor scents from disc-like element 50 to diffuse thereform.

In contrast, and with reference to FIG. 3, when a user causes the top lid member 14 to rotate or move relative the bottom container member 16 causing protruding portions 31, 33 of the serpentine or wave like patterns 26, 28 respectively on the top lid member 14 and the bottom container member 16 to abut one another, at least some of the plurality of apertures 24 of the bottom container member 16 are exposed thus enabling insect repellent scents to be diffused from the aforesaid disc-like element 50 and into the surrounding atmosphere, via the plurality of apertures 24.

It is to be also appreciated that the aforesaid described embodiments of the present invention, when not is use, may be placed in a scent retaining bag to further preserve the element used containing the insect repellent scent. And when an embodiment contains a liquid element, an air tight lid or seal member is to be used to prevent any unintended evaporation of the liquid element.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention has been described, it should be understood that various changes, substitutions, and alterations can be made by one of ordinary skill in the art without departing from the scope of the present invention.

What is claimed is:

1-20. (canceled)

21. A method for repelling insects comprising the steps of:
providing an apparatus that is configured to act as a diffuser and has a plurality of openings formed therein and has contained therein an insect repellant that is formed of a diffusible material that repels insects, and
opening the diffuser apparatus by uncovering the openings formed m the diffuser apparatus resulting in the insect repellent diffusing through the openings into the surrounding atmosphere to repel insects.

22. The method of claim 21, wherein the insect repellent comprises a disc that is inserted and is formed of the diffusible material.

23. The method of claim 21, wherein the diffusible material is coated along an inner surface of the apparatus.

24. The method of claim 21, wherein an inner wall of the apparatus is at least one of being infused, impregnated, and saturated with the diffusible material.

25. The method of claim 21, wherein the apparatus includes a first part and a second part that carries the diffusible material and includes the openings, the first and second parts being movable between an open position and a closed position, wherein in the closed position, diffusion of the diffusible material is prevented and in the open position, the diffusible material diffuses through the openings.

26. The method of claim 25, wherein the first and second parts move between the open and closed positions by rotation of the first part relative to the second part.

27. The method of claim 21, wherein the apparatus includes a bottom container member and a top lid member, the bottom container member including openings formed in a top portion of a continuous side wall of the bottom container member and wherein the step of opening the diffuser apparatus comprises the step of changing a position of the top lid member relative to the bottom container member.

28. The method of claim 27, wherein the top lid member is configured to detachably attach to and close off the top portion of the bottom container and the step of changing a position of the top lid member relative to the bottom container member comprises rotating the top lid member about the top portion of the bottom container between a first position wherein all the openings of the bottom container member are concealed and a second position in which at least some of the openings of the bottom container member are exposed.

29. The method of claim 21, wherein the insect repellent is in the form of liquid that comprises the diffusible material.

30. The method of claim 28, wherein the bottom container member has a first outer surface and a second outer surface extending from the first outer surface wherein the second outer surface forms a top portion of the bottom container member, the first outer surface of the bottom container member having a circumference substantially identical to that of an outer surface of the top lid member and the second outer surface of the bottom container member having a circumference Which is less than that of the outer surface of the top lid member such that the top lid member slideably receives on the second outer surface of the bottom container member.

31. The method of claim 30, wherein the first outer surface of the bottom container member defines a pattern along its upper surface and a bottom surface of the top lid member defines a pattern similar to that of the pattern of the first outer surface of the bottom container, wherein the top lid member is positioned in the second position when abutting portions of the respective patterns on the top lid member and the bottom container member are caused to abut one another and wherein the respective patterns of the top lid member and the bottom container member are configured in a wave like pattern.

32. The method of claim 21, wherein the apparatus includes a first part and a second part that carries the diffusible material and includes the openings, the first and second parts being movable between an open position and a closed position, wherein in the closed position, diffusion of the diffusible material is prevented and in the open position, the diffusible material diffuses through the openings.

33. The method of claim 32, wherein the apparatus includes a first part and a second part that carries the diffusible material and includes the openings, the first and second parts being movable between an open position and a closed position and wherein the step of opening the diffuser apparatus by uncovering the openings comprises moving the first part to the open position while the first and second parts remain in contact with one another.

34. The method of claim 21, wherein the apparatus includes a hollow interior that contains the insect repellent and the hollow interior and openings are constructed to create the diffuser and allow diffusion of the insect repellent.

35. The method of claim 21, wherein the apparatus includes a first part and a second part that carries the diffusible material and includes the openings, the first and second parts being movable between an open position and a closed position and wherein the step of opening the diffuser apparatus by uncovering the openings comprises moving the first part to the open position while the first and second parts remain in contact with one another and a top end of the second part remains closed off by the first part.

36. The method of claim 21, wherein the apparatus includes a bottom container member and a top lid member, wherein the bottom container member has an upper section and a lower section, the lower section having a circumference substantially identical to that of an outer surface of the top lid member and the upper section of the bottom container member having a circumference which is less than that of the outer surface of the top lid member such that the top lid member is slideably received on the upper section of the bottom container member, the openings being formed in the upper section.

37. A method for repelling insects comprising the steps of:
providing an apparatus that is configured to act as a diffuser and comprises a top lid member and a bottom container member, the bottom container member having a plurality of openings formed therein and the bottom container member has contained therein an insect repellant that is formed of a diffusible material that repels insects; and
opening the diffuser apparatus by uncovering the openings formed in the diffuser apparatus, while maintaining the coupling between the top lid member and the bottom container member with the top lid member closing off a top of the bottom container member so as to define a closed diffuse chamber, thereby resulting in the insect repellent diffusing through the openings into the surrounding atmosphere to repel insects.
